(19) United States
(12) Patent Application Publication
(10) Pub. No.: US 2026/0015217 A1
(43) Pub. Date: Jan. 15, 2026

(54) AUTOMATIC FORK ADJUSTMENT SYSTEM AND METHOD

(71) Applicant: Toyota Material Handling, Inc., Columbus, IN (US)

(72) Inventor: Gregory L. Eggersman, Columbus, IN (US)

(21) Appl. No.: 19/268,013

(22) Filed: Jul. 14, 2025

Related U.S. Application Data
(60) Provisional application No. 63/670,505, filed on Jul. 12, 2024.

(51) Int. Cl. B66F 9/24; B66F 9/075; B66F 9/22

(52) U.S. Cl. CPC B66F 9/24; B66F 9/0755; B66F 9/22

(57) ABSTRACT

An automatic fork adjustment system for a material handling vehicle including a position sensor module, an automatic fork height button, a hydraulics control system; and a microcontroller is provided. The position sensor module includes a processor, a power supply, and a height sensor. The microcontroller is communicatively coupled with the position sensor module, the automatic fork height button, and the hydraulics control system. The microcontroller is configured to send signals to the hydraulics control system to automatically adjust a height of a fork tine when the automatic fork height button is activated.

### CROSS-REFERENCE TO RELATED APPLICATION

This application claims priority to U.S. Provisional Patent Application No. 63/670,505, filed Jul. 12, 2024, the entire contents of which are incorporated herein by reference.

### BRIEF SUMMARY

This disclosure generally relates to material handling vehicles. More specifically, this disclosure relates to material handling vehicles equipped with an automatic fork adjuster system.

### BACKGROUND

Fork movement involves raising, lowering, shifting, and tilting the forks on a conventional material handling vehicle, like a forklift, to adjust for load height. Adjusting the load height usually involves activating a hydraulics system, which extends or retracts the forks, to appropriately position the forks under the load.

Fork tines can be susceptible to wear and tear from manual fork movement. Another common issue operators run into is fork tines dragging on the ground when the height of the fork tines is not properly adjusted.

### SUMMARY

Some embodiments provide an automatic fork adjustment system for a material handling vehicle including a position sensor module, an automatic fork height button, a hydraulics control system; and a microcontroller. The position sensor module includes a processor, a power supply, and a height sensor. The microcontroller is communicatively coupled with the position sensor module, the automatic fork height button, and the hydraulics control system. The microcontroller is configured to send signals to the hydraulics control system to automatically adjust a height of a fork tine when the automatic fork height button is activated.

In some embodiments, the fork tine is automatically adjusted to a predetermined height based on a height of a standard pallet. In some embodiments, the height of the standard pallet is six inches. In some embodiments, the predetermined height is selectable, adjustable, or a combination thereof by a user of the material handling vehicle.

In some embodiments, the position sensor module is configured to detect a current height of the fork tine and communicate the current height with the microcontroller to adjust the height of the fork tine from the current height to a preprogrammed height.

In some embodiments, the height sensor is communicatively connected to at least one controller configured to adjust one or more aspects of the material handling vehicle based on fork tine height. The one or more aspects include a vehicle speed, a turn radius, a headlight position, or a combination thereof.

Some embodiments provide a method of automatically adjusting a fork tine height on a material handling vehicle including determining a status of the material handling vehicle, activating an automatic fork height button, determining a current height of a fork tine using a height sensor, receiving a signal, after the automatic fork height button is activated, to automatically adjust the fork tine height based on the status and the current height, and actuating the fork tine to a predetermined height using a hydraulics control system of the material handling vehicle.

In some embodiments, the method further includes sending a signal from a controller of the material handling vehicle to the hydraulics control system to actuate the fork tine to the predetermined height.

In some embodiments, the method further includes adjusting at least one other aspect of the material handling vehicle based on the fork tine height, wherein the at least one other aspect includes a vehicle speed, a turn radius, a headlight, or a combination thereof.

In some embodiments, the predetermined height is selectable, adjustable, or a combination thereof a user of the material handling vehicle.

In some embodiments, the method further includes programming the predetermined height into a controller of the material handling vehicle using a user interface communicatively connected to the material handling vehicle.

In some embodiments, the fork tine is automatically adjusted to prevent the fork tine from dragging on the ground when the material handling vehicle is detected to be in motion and not transporting a load.

Some embodiments provide a material handling vehicle configured to automatically adjust a fork tine. The material handling vehicle includes a mast, a plurality of fork tines configured to be raised and lowered along the mast, a hydraulics control system operatively connected to the mast, an automatic fork adjustment system, and a controller. The automatic fork adjustment system includes an automatic fork height adjustment button positioned to be accessible to an operator of the material handling vehicle, and a position sensor module. The position sensor module includes a processor, a power supply, and a height sensor configured to determine a current height of the plurality of fork tines. The controller is communicatively connected to the position sensor module and the hydraulics control system. The controller is configured to receive a signal from the automatic fork height adjustment button and adjust the plurality of fork tines to a predetermined height using the hydraulics control system.

In some embodiments, the predetermined height is based on a standardized pallet height. In some embodiments, a material handling vehicle, the standardized pallet height is between about 4 inches and about 7 inches tall. In some embodiments, the standardized pallet height is 6.5 inches tall.

In some embodiments, the predetermined height is selectable by an operator of the material handling vehicle. In some embodiments, the predetermined height is adjustable by an operator of the material handling vehicle.

In some embodiments, the controller is configured to adjust one or more aspects of the material handling vehicle based on a height of the plurality of fork tines. The one or more aspects include a vehicle speed, a turn radius, a headlight position, or a combination thereof.

In some embodiments, the height sensor is communicatively connected to a mast hydraulic sensing system.

### BRIEF DESCRIPTION OF DRAWINGS

FIG. 1A is a side elevation view of a material handling vehicle according to one embodiment;

FIG. 1B is a schematic illustration of a hydraulics control system of the material handling vehicle of FIG. 1A;

FIG. 2 is a top view of various operator controls of the material handling vehicle of FIG. 1A;

FIG. 3 is a block diagram of system components of a fork adjustment system of the material handling vehicle of FIG. 1A; and

FIG. 4 is a flow diagram of a method for automatically adjusting the height of a fork according to one embodiment.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, or C. As such, this phrase, and similar other phrases can include single or multiple instances of A, B, or C, and, in the case that any of A, B, or C indicates a category of elements, single or multiple instances of any of the elements of the categories A, B, or C.

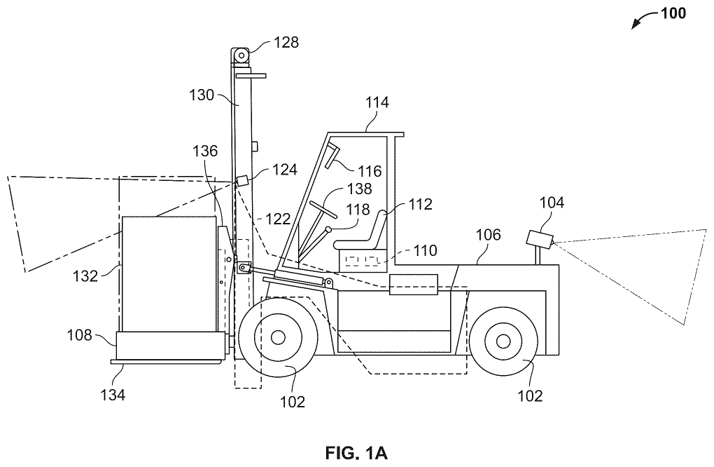

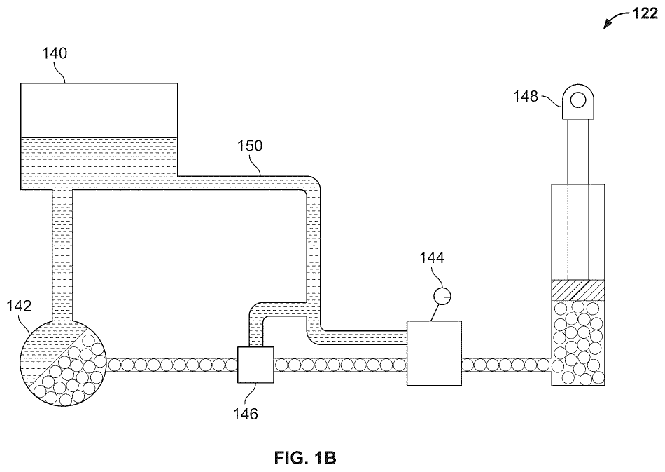

FIG. 1A illustrates a material handling vehicle 100 according to one embodiment. The primary function of the material handling vehicle 100 is to lift, transport, and deposit a load of material. The material handling vehicle 100 can comprise wheels 102, a rear-facing sensor 104, a body 106, one or more feedback devices 110, a driver's seat 112, an operator cab 114, a display module 116, an operator control module 118, a mast 130, fork tines 134, and a steering wheel 138. In some embodiments, the material handling vehicle 100 is operated by a driver or operator who sits in the driver's seat 112, but in some other forms, the material handling vehicle can operate autonomously or via remote control. In the manual driver operation form, the operator can use the operator control module 118 to control the material handling vehicle 100. The operator control module 118 can be provided in the form of one or more control levers. For example, the operator control module 118 could be used to shift the material handling vehicle 100 into forward or backward motions. Additionally, the operator control module 118 could be used to operate and/or adjust the height of the fork tines 134. There may also be other control levers or instruments not pictured that the driver may use to control the material handling vehicle 100.

The mast 130 includes a load backrest 136, a hydraulics control system 122, and a chain wheel 128. A pallet 108 and a load 132 may be positioned between the fork tines 134 and the load backrest 136 for relocation by the operator of the material handling vehicle 100.

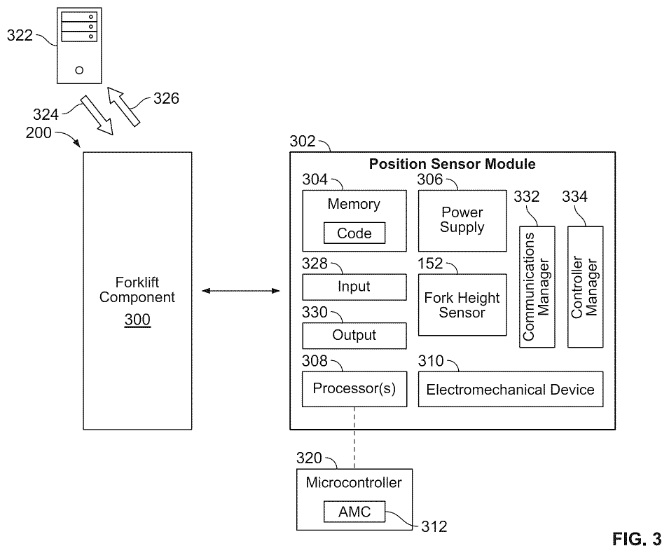

The material handling vehicle 100 includes an automatic fork adjustment system that comprises the hydraulics control system 122 (described in more detail in connection with FIG. 1B), one or more position sensors 124, and a forklift component 300 (see FIG. 3). The hydraulics control system 122, the one or more position sensors 124, and the forklift component 300 are all communicatively coupled to one another and can exchange information via wired or wireless communication protocols. Non-limiting examples of the communication protocols include wired, wireless, Bluetooth, cellular, satellite, GPS, RS-485, RF, MODBUS, CAN, CANBUS, ZigBee, DeviceNet, ControlNet, Ethernet TCP/IP, RS-232, Universal Serial Bus (USB), Firewire, Thread, proprietary protocol(s), or other known communication protocol(s) as applicable.

The one or more position sensors 124 can be provided in the form of one or more cameras, laser scanners, accelerometers, gyro sensors, proximity sensors, radars, LiDAR, optical sensors (e.g., infrared sensors), acoustic sensors, barometers, thermometers, other suitable sensors, or any combination thereof. The one or more position sensors 124 are positioned to sense the environment in front of the material handling vehicle 100 and can be attached to the mast 130 or another portion of the front end of the material handling vehicle 100.

The rear-facing sensor 104 is positioned to sense the environment behind the material handling vehicle 100 and can be mounted on or otherwise integrated with the rear end of the body 106, for example.

Both the one or more position sensors 124 and the rear-facing sensor 104 can sense parameters of the environment surrounding the material handling vehicle 100, such as visual, auditory, or other environmental features, generate sensor data, and communicate the corresponding sensor data with a processor 308 of the position sensor module 302 (as shown in FIG. 3).

FIG. 1B illustrates a hydraulics control system 122 of the material handing vehicle of FIG. 1A. The hydraulics control system 122 generates a force needed to raise, lower, widen, narrow, shift, and tilt the fork tines 134 or forklift attachments that secure the pallet 108 and the load 132. The hydraulics control system 122 includes a tank 140, a pump 142, a control valve 144 a relief valve 146, one or more cylinders 148, and a return line 150.

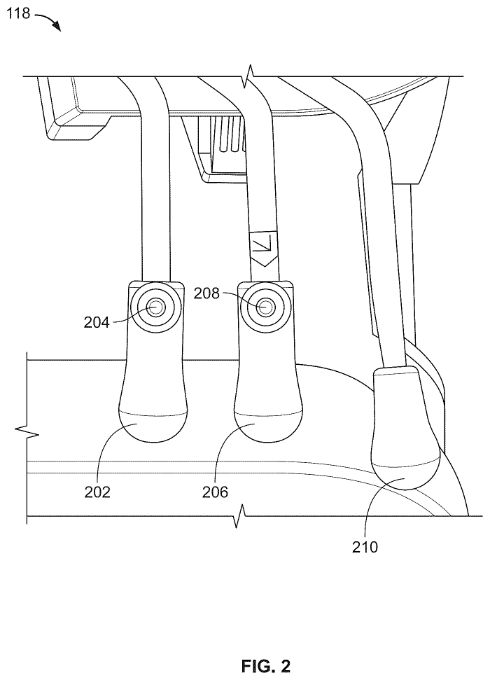

The tank 140 is embedded into, or otherwise integrated with, the body 106 of the material handling vehicle 100 and is provided in the form of a container designed to hold the hydraulic fluid. The hydraulics control system 122 can utilize water-based, oil-based, or synthetic fluids. The pump 142 is operatively connected to the tank 140 and is designed to push the hydraulic fluid in one direction and maintain a steady flow. The control valve 144 is operatively connected to the one or more cylinders 148, the relief valve 146, and an up and down fork lever 202 (as described in connection with FIG. 2). The control valve 144 regulates hydraulic fluid flow direction to raise, lower, tilt, shift, or hold the load. The relief valve 146 functions as a safety feature in the hydraulics control system 122. By relieving excess pressure within the hydraulics control system 122, the relief valve 146 prevents excess pressure, which may cause ruptured hoses, leaking connections, and other potential safety issues. The one or more cylinders 148 translate the based on the control valve position and the pressure of hydraulic fluid in the one or more cylinders 148. The return line 150 reroutes the hydraulic fluid to the tank 140 after the pressure created by the hydraulics control system 122 is released and the fork tines 134 shift back to the original position.

FIG. 2 illustrates a top view of the operator control module 118. The operator control module 118 may be located in the operator cab 114 of the material handling vehicle 100 adjacent to the steering wheel 138. The operator control module 118 is designed to be a primary interface between the operator of the material handling vehicle 100 and the hydraulics control system 122. The operator control module 118 can form part of an automatic fork adjustment system 200 designed to control the movement and positioning of the fork tines 134, the mast 130, and additional mechanical attachments. The automatic fork adjustment system 200 allows an operator of the material handling vehicle 100 to lift, lower, tilt forward or backward, shift left and right, and move loads 132 or pallets 108 with precision and control.

The automatic fork adjustment system 200 includes an up and down fork lever 202, a fork tilt lever 206, a fork side shift lever 210, the hydraulics control system 122, and the one or more position sensors 124. The one or more levers 202, 206, 210 may be arranged in a logical sequence to make them easier to use by an operator of the material handling vehicle 100. Although the automatic fork adjustment system 200 is shown with levers, in some aspects, the controls may be switch buttons or other actuators.

The fork side shift lever 210 allows the operator to move the fork tines 134 laterally from left to right. The fork side shift lever 210 enables the operator of the material handling vehicle 100 to maneuver loads 132 that are positioned in tighter corners and narrower aisles, which allows the operator to position and pack more loads 132 into a desired space.

The fork tilt lever 206 controls the angle of the fork tines 134 relative to the ground by allowing the operator to tilt the fork tines 134, mast 130, and consequently the load 132, backward and forward. The fork tilt lever 206 is operatively connected to the one or more cylinders 148 of the hydraulics control system 122. The one or more cylinders 148 may include a tilt cylinder, a lift cylinder, and or a shift cylinder. For example, the fork tilt lever 206 can be operatively connected to a tilt cylinder, which allows for the hydraulic movement of the mast 130 to tilt forward or rearward with respect to the body 106 of the material handling vehicle 100. The fork tilt lever 206 can help prevent the load 132 or the pallet 108 from slipping off of the fork tines 134.

The fork tilt lever 206 includes a fork level button 208. The fork level button 208 is operatively connected to an active mast function controller (AMC) 312 (as shown in FIG. 3), the one or more position sensors 124, and the hydraulics control system 122. The AMC 312 is operatively connected to the mast 130. By pressing the fork level button 208, the AMC 312 communicates with the mast 130 and automatically levels the fork tines 134. The fork level button 208 allows for an operator of the material handling vehicle 100 to keep the load 132 and/or pallet 108 stable and secure while lifting, placing, or removing the load 132 and/or pallet 108 from a location. Additionally, the fork level button 208 helps the fork tines 134 keep the load 132 and/or pallet 108 more stable and secure while lifting and/or transporting. This reduces the risk of spillage, tip over, and material handling vehicle 100 accidents.

The up and down fork lever 202 is used to move the fork tines 134 vertically up and down. The up and down fork lever 202 is operatively connected to the chain wheel 128, which is used to physically move the load 132 up and down along the mast 130 of the material handling vehicle 100. The fork tines 134 and load backrest 136 are raised and lowered with the help of the hydraulics control system 122, and more particularly, the one or more cylinders 148. The up and down fork lever 202 allows the fork tines 134 to lift the load 132, and more particularly, the pallet 108 and transport the load 132 and/or pallet 108 to a different location.

The height of a standard pallet is six inches. To lift the pallet 108, the fork tines 134 are raised to a height of three to five inches off of the ground on which the pallet 108 rests. The up and down fork lever 202 thus provides control of the fork tines 134 to move vertically up and down along the mast 130 to pick up and lift a desired pallet 108.

The up and down fork lever 202 can also include an automatic fork height button 204, or an automatic fork button 204 can also be provided in another part of the operator cab 114, such as along the dashboard. The automatic fork height button 204 is operatively connected to the AMC 312, one or more position sensors 124, and the hydraulics control system 122. The AMC 312 is also operatively connected to the mast 130. When the automatic fork height button 204 is pressed, the AMC 312 communicates with the hydraulics control system 122 and/or the mast 130 and automatically sends the fork tines 134 to a predetermined, user-selectable, or preprogrammed height.

For example, in one embodiment, a predetermined height based on the height of a standard pallet may be programmed into the automatic fork adjustment system 200. When an operator presses the automatic fork height button 204 on the up and down fork lever 202, the fork tines 134 will move either up or down (depending on the current height of the fork tines 134) to between three and five inches off of the ground. At the predetermined height, the fork tines 134 can be positioned into the pockets of the pallet 108 in preparation for lifting the load 132 off of the ground and transporting it.

In another embodiment, an operator can manually program a preprogrammed height to which the fork tines 134 will adjust when the automatic fork height button 204 is pressed. For example, if an operator is moving a large number of pallets 108 off of a raised surface that is ten inches off the ground, the operator can program the automatic fork height button 204 to a height of thirteen to fifteen inches (raised surface height+preprogrammed height based on standardized pallet height) off of the ground. When the operator presses the automatic fork height button 204 on the up and down fork lever 202, the fork tines 134 will move either up or down (depending on the current height of the fork tines 134) to between thirteen and fifteen inches off of the ground. At this height, the fork tines 134 can be positioned into the pockets of the pallet 108 in preparation for lifting the load 132 from the raised surface and transporting it.

The automatic fork height button 204 helps prevent dragging the fork tines 134 on the ground when the material handling vehicle 100 is in motion and not in the process of transporting a load 132. which, in turn, increases the lifespan of the fork tines 134. Further, the automatic fork height button 204 increases the efficiency and productivity of lifting, transporting, and depositing a load safely.

FIG. 3 illustrates a block diagram of system components of the automatic fork adjustment system 200 which includes the material handling vehicle 100, a forklift component 300, a position sensor module 302, and a microcontroller 320 with the AMC 312, which may be coupled or otherwise connected to the position sensor module 302 and connected to a server 322, according to an example. The forklift component 300 includes one or more of the up and down fork levers 202, the automatic fork height button 204, the mast 130, the load backrest 136, the fork tines 134, and a fork height sensor 152. The material handling vehicle 100, the forklift component 300, the position sensor module 302, and the microcontroller 320 may be examples of, or include aspects of, the material handling vehicle 100, the forklift component 300, the position sensor module 302, and the microcontroller 320 of FIGS. 1A, 1B, and 2, respectively.

In some embodiments, the microcontroller 320 can be provided in the form of a single-board microcontroller. In some embodiments, the microcontroller 320 can be provided in the form of an Arduino, Raspberry Pi, controller, a central processing unit (CPU), or other similar processing unit. The microcontroller 320 may be designed to execute programs, software, or programmable instructions stored on a memory module 304. In some aspects, the microcontroller 320 includes an AMC 312 (as described in connection with FIG. 2).

The position sensor module 302 can further include the memory module 304, a power supply module 306, a processor 308, and an electromechanical device 310. The memory module 304 can be provided in the form of one or more memory units, including remotely connected memory banks or devices.

The at least one power supply module 306 may include or be provided in the form of one or more of at least one battery, at least one photovoltaic cell, a wired connection to an electrical system, or another type of power source. In some examples, the at least one power supply module 306 may be a separate battery for the position sensor module 302. Alternatively, the at least one power supply module 306 may be a power source associated with a motor or engine of the material handling vehicle 100, such as a battery that starts or powers the material handling vehicle 100 or may be operatively coupled to the power supply source for the material handling vehicle 100. The power supply module 306 may also be provided in the form of one or more rechargeable power sources.

In some aspects, the processor 308 is communicatively coupled to the memory module 304 and is configured to execute programmable instructions. In some embodiments, the electromechanical device 310 can be provided in the form of a rotary encoder, a potentiometer, or a similar device to measure the height of the fork tines 134. In some embodiments, the electromechanical device 310 can include the position sensor 124. In some embodiments, the position sensor module 302 can include a weight sensor, contact switch, or similar sensing device, to determine if an operator is present in the driver's seat 112. In some embodiments, the weight sensor can be positioned within or underneath the driver's seat 112.

In some embodiments, the position sensor module 302 is designed to communicate with the electromechanical device 310 to indicate when the fork tines 134 are in the desired position. The desired position can either be a level position after the fork level button 208 has been pressed by the operator, a predetermined height after the automatic fork height button 204 has been actuated by the operator, or a preprogrammed height after the automatic fork height button 204 has been actuated by the operator.

The fork height sensor 152 may be connected to one or more controllers (including but not limited to the onboard controller) to adjust or otherwise control other aspects of the material handling vehicle 100. For example, a speed, a turn radius, a headlight position, etc. of the material handling vehicle 100 may be adjusted or controlled based on the height of the fork tines 134. Additionally, the fork height sensor 152 can be communicatively connected to a mast hydraulic sensing system, including but not limited to the mast hydraulic sensing system of U.S. patent application Ser. No. 19/175,110, filed Apr. 10, 2025, incorporated herein by reference in its entirety.

The material handling vehicle 100 may be in communication with one or more servers 322. The material handling vehicle 100 may communicate with the one or more servers 322 using communication links, such as an uplink 324 and a downlink 326. The one or more servers 322 may store data including a map of the area (e.g., a map of the warehouse), historical image data from at least one camera, other sensor data, driving records of at least one operator, performance data, and the like. The one or more servers 322 may send at least some of this data to the position sensor module 302 via the downlink 326. In some examples, the one or more servers 322 may gather at least some of the data based on a request from the material handling vehicle 100. In some examples, the one or more servers 322 may send data to the material handling vehicle 100 when it receives at least one signal indicating that the operator of the material handling vehicle 100 is approaching a pallet or otherwise preparing the material handling vehicle 100 to lift a pallet.

In some examples, the map of the warehouse may include a perimeter of the outside of the warehouse, nearby features located outside the warehouse, the location of shelves and aisles in the warehouse, locations of intersections within the warehouse, locations of additional storage areas or rooms within the warehouse, locations for any proximity detectors of the warehouse, location of warehouse doors and windows, and the like. The position sensor module 302 may use the map to determine if a threshold angle should be adjusted or to make any other adjustment to the operations of the forklift component 300.

The position sensor module 302 may include at least one input device 328 and at least one output device 330. The at least one input device 328 and the at least one output device 330 may represent a device integrated into the position sensor module 302 or a physical connection or port to an external peripheral device. The at least one input device 328 may be one or more of a modem, a keyboard, a mouse, a touchscreen, a microphone, a trackball, a joystick, or a similar device. The at least one output device 330 may be one or more of a display, screen, or monitor, a speaker including headphones, or a similar device. In some examples, an input device 328 and an output device 330 may be a single device. The at least one input device 328 and the at least one output device 330 may be located anywhere on the material handling vehicle 100 or may be external to the material handling vehicle 100.

In some forms, the at least one input device 328 or at least one output device 330 may be located within a passenger compartment of the material handling vehicle 100. For example, at least one of the output devices 330 may be a display that is located within the operator cab 114 of the material handling vehicle 100 at or near the automatic fork adjustment system 200.

The one or more position sensors 124 may further include independent internal or external photoreceptors, which may be used to determine environmental conditions proximate to the material handling vehicle 100. The environmental conditions may be provided to the position sensor module 302, which may use the information in determining when to provide feedback to the operator for adjusting the height of the forklift component 300. For example, the position sensor module 302 may be more conservative when conditions are poorer for operating the material handling vehicle 100, such as when a spill has made the floor of a warehouse slick, or less conservative when conditions are better, such as when no pedestrians are in the area.

The memory module 304 may include random access memory (RAM) and read-only memory (ROM). The memory module 304 may store computer-readable, computer-executable, or processor-executable code. Processor-executable code may include instructions that, when executed by the at least one processor 308 cause the position sensor module 302 to perform various functions described herein. Processor-executable code may be stored in a non-transitory computer-readable medium such as system memory or another type of memory. In some cases, the processor-executable code may not be directly executable by the at least one processor 308 but may cause a computer (e.g., when compiled and executed) to perform functions described herein. In some cases, the memory module 304 may include, among other things, a basic I/O system (BIOS) which may control basic hardware or software operation such as the interaction with peripheral components or devices.

In some examples, the at least one processor 308 may include one or more processors and the memory module 304 may include multiple memories. One or more of the multiple processors 308 may be coupled with one or more of the multiple memories, which may, individually or collectively, be configured to perform various functions described herein. In some examples, the at least one processor 308 may be a component of a processing system, which may refer to a system (such as a series) of machines, circuitry (including, for example, one or both of processor circuitry (which may include the at least one processor 308) and memory circuitry (which may include the memory module 304)), or components, that receives or obtains inputs and processes the inputs to produce, generate, or obtain a set of outputs. The processing system may be configured to perform one or more of the functions described herein. For example, the at least one processor 308 or a processing system including the at least one processor 308 may be configured to, configurable to, or operable to cause the position sensor module 302 to perform one or more of the functions described herein. Further, as described herein, being “configured to,” being “configurable to,” and being “operable to” may be used interchangeably and may be associated with a capability, when executing code (e.g., processor-executable code) stored in the memory module 304 or otherwise, to perform one or more of the functions described herein.

In some examples, the position sensor module 302 may include a communications manager 332. The communications manager 332 may facilitate communication between the material handling vehicle 100 and the one or more servers 322 and/or communication between the various components of position sensor module 302 and the one or more servers 322 via at least one wired or wireless communication link, such as the uplink 324 and the downlink 326. In some cases, the communications manager 332 may be implemented as part of the at least one processor 308.

The position sensor module 302 may further include a controller manager 334. The controller manager 334 may facilitate operation of the material handling vehicle 100. The controller manager 334 may receive signals from a directional level control, the microcontroller 320, a transmission, or combination thereof. The controller manager 334 may perform one or more mitigating actions from the forklift component 300. The one or more mitigation actions that the controller manager 334 may perform can include correcting the adjusted the height of the fork tines 134, raising the fork tines 134, lowering the fork tines 134, slowing the material handling vehicle 100, stopping the material handling vehicle 100, shifting a gear of the material handling vehicle 100, turning the material handling vehicle 100, operating a horn, operating a light, preventing acceleration of the material handling vehicle 100, and the like. In some examples, the mitigating action may include reducing a speed of the material handling vehicle 100. In some examples, the movement of the material handling vehicle 100 may be temporarily restricted by the controller manager 334. In some examples, the one or more mitigation actions can be customized by a higher clearance operator depending on specific needs.

In some examples, the communications manager 332 and the controller manager 334 may be configured to perform various operations (e.g., receiving, obtaining, monitoring, outputting, transmitting, processing, analyzing, etc.) using or otherwise in cooperation with the various components of the position sensor module 302. For example, the communications manager 332 and the controller manager 334 may receive information from at least some of the components, send information to at least some of the components, or be integrated in combination with the components to obtain information, output information, or perform various other operations as described herein.

As described herein, the position sensor module 302 or processor 308 thereof may communicate with the electromechanical device 310 to indicate when the fork tines 134 are in the desired position. The desired position can either be a level position after the fork level button 208 has been pressed by the operator, a predetermined height after the automatic fork height button 204 has been actuated by the operator, or a preprogrammed height after the automatic fork height button 204 has been actuated by the operator.

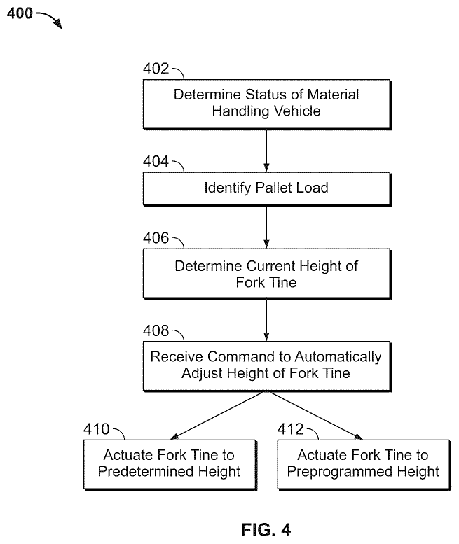

FIG. 4 illustrates an example embodiment of a method 400 of automatically adjusting the fork height of the material handling vehicle 100. The automatic fork adjustment system 200 determines a vehicle status at step 402 to determine whether the material handling vehicle 100 is ready for operation. The process for determining the vehicle status can include, but is not limited to, identifying a state of a key switch, identifying an operator presence (e.g., weight sensor, image processing, motion detection, etc.), identifying an authentication, or a combination thereof. When the automatic fork adjustment system 200 determines that the vehicle is ready for operation, the operator or the vision system identifies the pallet load at step 404. The process for identifying the pallet load can include locating the pallet 108 and/or load 132 that the operator intends to transport with the material handling vehicle 100. When the pallet load has been identified, the position sensor 124 determines the present height of the fork tines 134 at step 406. When the current fork tine height has been determined, the automatic fork adjustment system 200 sends and/or receives the command and/or signal to automatically adjust the height of the fork tines 134 at step 408. The command and/or signal can be initiated by actuating the automatic fork height button 204 or by a signal sent from the microcontroller 320. Once the command to automatically adjust the fork height has been received, the fork tines 134 are actuated and/or positioned to the defined pallet height at step 410. In another embodiment, the fork tines 134 can be positioned and or actuated to a desired preprogrammed height at step 412.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An automatic fork adjustment system for a material handling vehicle comprising:
a position sensor module that includes:
a processor,
a power supply, and
a height sensor;
an automatic fork height button;
a hydraulics control system;
a microcontroller communicatively coupled with the position sensor module, the automatic fork height button, and the hydraulics control system,
wherein the microcontroller is configured to send signals to the hydraulics control system to automatically adjust a height of a fork tine when the automatic fork height button is activated.

2. The automatic fork adjustment system of claim 1, wherein the fork tine is automatically adjusted to a predetermined height based on a height of a standard pallet.

3. The automatic fork adjustment system of claim 2, wherein the height of the standard pallet is six inches.

4. The automatic fork adjustment system of claim 2, wherein the predetermined height is selectable, adjustable, or a combination thereof by a user of the material handling vehicle.

5. The automatic fork adjustment system of claim 1, wherein the position sensor module is configured to detect a current height of the fork tine and communicate the current height with the microcontroller to adjust the height of the fork tine from the current height to a preprogrammed height.

6. The automatic fork adjustment system of claim 1, wherein the height sensor is communicatively connected to at least one controller configured to adjust one or more aspects of the material handling vehicle based on fork tine height, wherein the one or more aspects include a vehicle speed, a turn radius, a headlight position, or a combination thereof.

7. A method of automatically adjusting a fork tine height on a material handling vehicle comprising:
determining a status of the material handling vehicle;
activating an automatic fork height button;
determining a current height of a fork tine using a height sensor;
receiving a signal, after the automatic fork height button is activated, to automatically adjust the fork tine height based on the status and the current height; and
actuating the fork tine to a predetermined height using a hydraulics control system of the material handling vehicle.

8. The method of claim 7, further comprising:
sending a signal from a controller of the material handling vehicle to the hydraulics control system to actuate the fork tine to the predetermined height.

9. The method of claim 7, further comprising:
adjusting at least one other aspect of the material handling vehicle based on the fork tine height, wherein the at least one other aspect includes a vehicle speed, a turn radius, a headlight, or a combination thereof.

10. The method of claim 7, wherein the predetermined height is selectable, adjustable, or a combination thereof a user of the material handling vehicle.

11. The method of claim 7, further comprising:
programming the predetermined height into a controller of the material handling vehicle using a user interface communicatively connected to the material handling vehicle.

12. The method of claim 7, wherein the fork tine is automatically adjusted to prevent the fork tine from dragging on the ground when the material handling vehicle is detected to be in motion and not transporting a load.

13. A material handling vehicle configured to automatically adjust a fork tine, the material handling vehicle comprising:
a mast;
a plurality of fork tines configured to be raised and lowered along the mast;
a hydraulics control system operatively connected to the mast;
an automatic fork adjustment system comprising:
an automatic fork height adjustment button positioned to be accessible to an operator of the material handling vehicle, and
a position sensor module comprising:
a processor,
a power supply, and
a height sensor configured to determine a current height of the plurality of fork tines; and
a controller communicatively connected to the position sensor module and the hydraulics control system, wherein the controller is configured to receive a signal from the automatic fork height adjustment button and adjust the plurality of fork tines to a predetermined height using the hydraulics control system.

14. The material handling vehicle of claim 13, wherein the predetermined height is based on a standardized pallet height.

15. The material handling vehicle of claim 14, wherein the standardized pallet height is between about 4 inches and about 7 inches tall.

16. The material handling vehicle of claim 14, wherein the standardized pallet height is 6.5 inches tall.

17. The material handling vehicle of claim 13, wherein the predetermined height is selectable by an operator of the material handling vehicle.

18. The material handling vehicle of claim 13, wherein the predetermined height is adjustable by an operator of the material handling vehicle.

19. The material handling vehicle of claim 13, wherein the controller is configured to adjust one or more aspects of the material handling vehicle based on a height of the plurality of fork tines, wherein the one or more aspects include a vehicle speed, a turn radius, a headlight position, or a combination thereof.

20. The material handling vehicle of claim 13, wherein the height sensor is communicatively connected to a mast hydraulic sensing system.
